(19) United States
(12) Patent Application Publication
(10) Pub. No.: US 2010/0237305 A1
(43) Pub. Date: Sep. 23, 2010

(54) Method of improving the functionality of pole mounted electrical producing or consuming panels

(76) Inventor: Kevin L. Miller, Pasadena, MD (US)

Correspondence Address: Gregory G. Dunn, 3613 Horned Owl Court, Ellicott City, MD, 21042, US

(21) Appl. No.: 12/406,129

(22) Filed: Mar. 18, 2009

(51) Int. Cl. B66D 1/20; B66D 1/00

(52) U.S. Cl. 254/358; 254/264

(57) ABSTRACT

Current pole/mast mounted photovoltaic systems rely on gravity to lower the panel down the mast. The energy derived is typically conducted along a coiled conductor that expands or collapses like a spring inside the hollow mast as the movable device, with the solar panel attached, is raised or lowered for maintenance. Due to the large size and stiffness of the coiled conductor, especially in cold weather, the weight of the movable device may not be sufficient to cause the panel to descend when tension on the supporting cable is released. We have developed a method of pulling the sleeve/ring down the mast/pole as well as up. Over long periods of non-use, the sleeve can freeze in position. This new system aids in freeing it up and is also useful when there is un-even side loading on the sleeve. A winch driven chain or cable, attached to the movable device, extending upward to a top roller then internally downward to the winch and then externally extending back up to the movable device, accomplishes this task. A further improvement is a plurality of vertical guide wires and guides attached to the conductor coils that prevent the coils from overlapping in the collapsing mode. An additional improvement is taught wherein the coiled conductor is replaced by a set of conducting rails with a shorter conductor attached to the solar panel.

### REFERENCES CITED

U.S. Patent Document

| | | |
|---|---|---|
| 5,975,726 | November 1999 | Latim er |
| 4,115,845 | September 1978 | Blahut |
| 3,801,813 | April 1974 | Keihn |
| 3,673,403 | June 1972 | Woods |

### FIELD OF THE INVENTION

This invention is related to pole/mast mounted devices.

### BACKGROUND OF THE INVENTION

Pole mounted solar panels are placed along remote stretches of railways to power signals and sensors. These are attended infrequently. Prior art for pole/mast mounted devices shows reliance upon gravity to lower the mounted device down the mast for maintenance. For applications where the device is infrequently lowered or where the device places a substantial side loading on the mast, gravity may not be sufficient to lower the device. Due to long periods of inactivity, the device may become stuck to the mast due to corrosion, debris or freezing. A positive means of pulling the device downward is advantageous in these situations. Vandalism is another threat so the electrical conductor is typically housed inside a metal mast so it is not exposed. This requires a coiled configuration inside the mast to allow for expansion as the panel is lowered for maintenance. When raising the panel, the coils often overlap inside the hollow mast causing binding during the next lowering session. The necessity for the coiled configuration also adds length and thus increased electrical resistance to the circuit, degrading the efficiency of the system.

The present invention overcomes the aforementioned limitations by using a method of both pulling the device downward as well as upward. The device to be moved is attached to both ends of a chain, one end of which travels downward and over a sprocket driven by a winch located near the base of the mast. The upper portion of the chain travels over a direction-changing idler sprocket located near the top of the mast and then to the winch. In this configuration, a controlled downward force, independent of gravity, can be exerted upon the movable device.

This system remains quite simple, reliable and inexpensive. An added advantage to using the chain is that it is harder to cut by vandals than a cable would be. An alternative method of accomplishing the positive pull in both directions is to utilize a cable in place of the aforementioned chain. In this application, the cable is either wound around two separate drums that are simultaneously controlled by a winch. One drum reels the cable in to accomplish the downward pull while the other drum plays out. The drum rotation is reversed to accomplish the upward pull. Alternatively, the cable can be wound in opposite directions on one drum, which is separated into two areas by a central separator. In this application, the cable movement is typically unequal per revolution of the drum due to the larger effective diameter of one side of the drum caused by the accumulated cable on that side. This slight difference can be overcome by inserting an accumulator into one cable's attachment to the movable device. This can be a simple spring that takes up the difference between the two cable's movements.

### SUMMARY OF THE INVENTION

The present invention describes a method of providing both a positive pull downward as well as upward to a movable device supported by a pole or mast. An improvement is described wherein the coiling of the coiled conductor inside the hollow mast is guided by guy wires thus preventing them from overlapping during the raising cycle of the movable panel. A further improvement is described wherein the coiled conductor is replaced by a shorter straight segment of conductor connected to slidable connectors riding on a rail system inside the mast thus reducing the electrical resistance of the long coil of conductor.

### DRAWINGS

The various objects and features of this invention will be fully understood from the following detailed description of the typical preferred form and application thereof, throughout which description, reference is made to the accompanying drawings, in which:

FIG. 1 is a vertical section of a typical mast showing the components comprising the present invention with a coiled electrical cable and chain hoisting member.

FIG. 2 is vertical section of a typical mast showing a cable and dual drum winch operating mechanism with electrical rails and slidable electrical cable contactors

FIG. 2A is a top view of a cable winch with two separate driven drums

FIG. 3 is vertical section of a typical mast showing the cable and segregated cable winding area winch operating mechanism

FIG. 3A is a front view of a cable winch with segregated cable winding areas

### PREFERRED EMBODIMENT

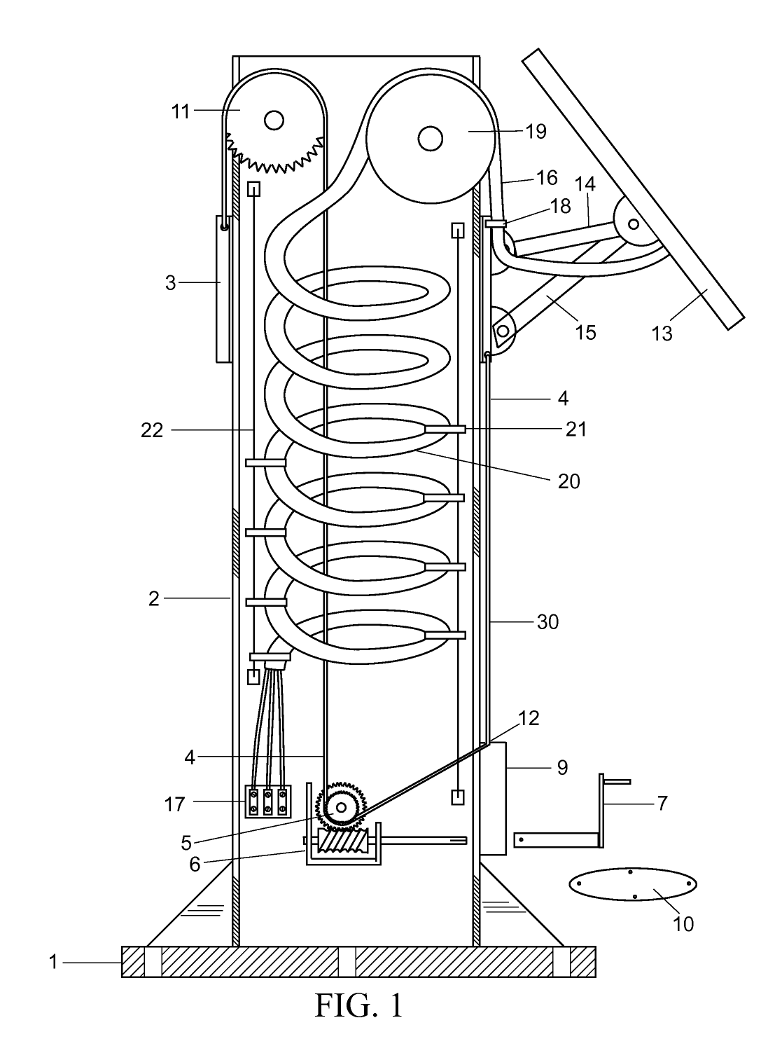

Referring now to FIG. 1 of the drawings, the said invention consists of a base 1, attached to mast 2 supporting movable device 3 which is caused to move up and down mast 2 by chain 4. Chain 4 is driven by sprocket 5 attached to winch 6 turned by crank 7. Winch 6 is accessible through access hatch 9 once hatch cover 10 is removed. One section of chain 4 passes upward through the center of mast 2, over upper idler sprocket 11 then downward to attach to and thus support movable object 3. The other section of chain 4 leaves winch sprocket 5, exits through a hole 12 in access hatch 9, and extends upward to attach to movable object 3 to provide the downward force needed to lower movable device 3. Electrical panel 13 is supported by brackets 14 and 15 which are attached to movable device 3. Electrical cable 16 conducts derived electrical power to load terminal block 17 in base 1. Electrical cable 16 passes through attachment clamp 18 on movable device 3, up and over upper cable roller 19 then down the center of the hollow mast 2 forming itself into a spiral coil 20, formed at the time of its manufacture.

Coil 20 is guided vertically by guides 21 attached to alternate coil loops as guides 21 slide up and down guide wires 22 fastened at top and bottom inside mast 2.

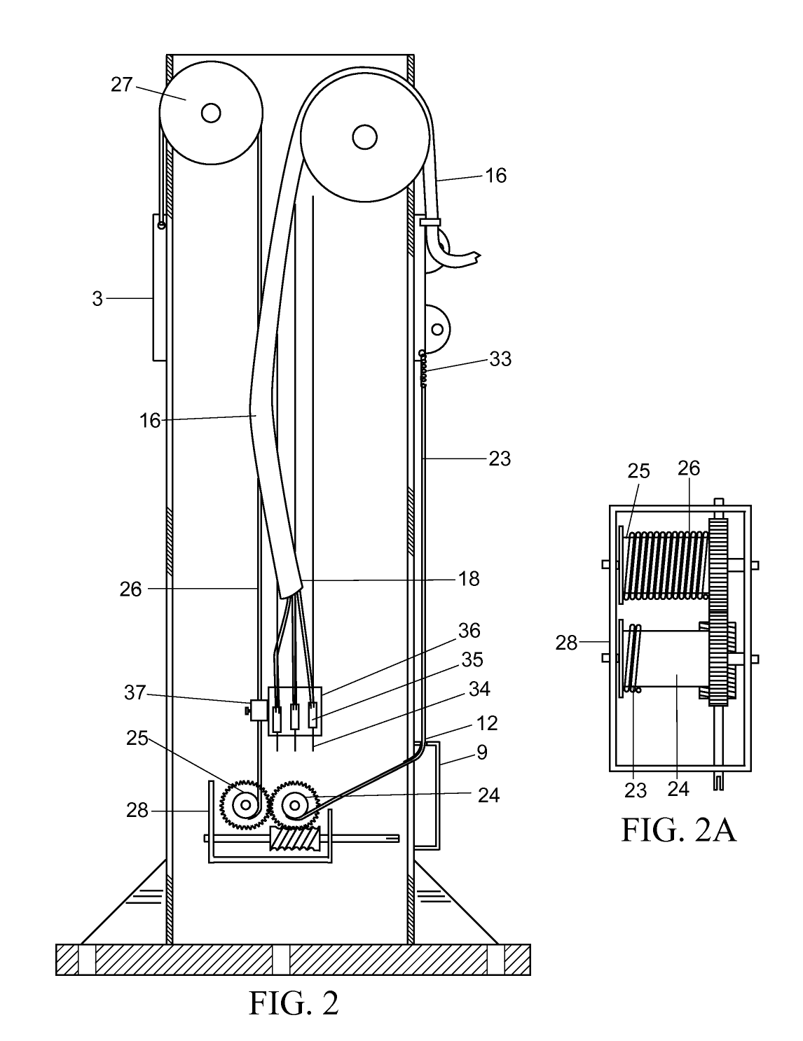

Referring now to FIG. 2 of the drawings, one can see cable 23 with one end attached to movable device 3, passing through hole 12 in access hatch 9 and wound around drum 24. Drum 24 drives drum 25 which winds cable 26 out as drum 24 winds cable 23 in. The other end of cable 26 passes upward through the center of mast 2, over upper pulley 27 and down to attach to movable device 3. FIG. 2 also shows an alternative electrical rail system 34 attached to the inside of mast 2. The lower end 18 of electrical cable 16 terminates in slidable electrical contactors 35 contained in retention block 36 which is made to ride up and down rail system 34 by attachment 37 to the chain 4, cable 26 or cable 30.

FIG. 2A is a top view of winch 28 containing two interconnected drums 24 and 25 which allows cable 23 to be wound in at the same rate that cable 26 is let out.

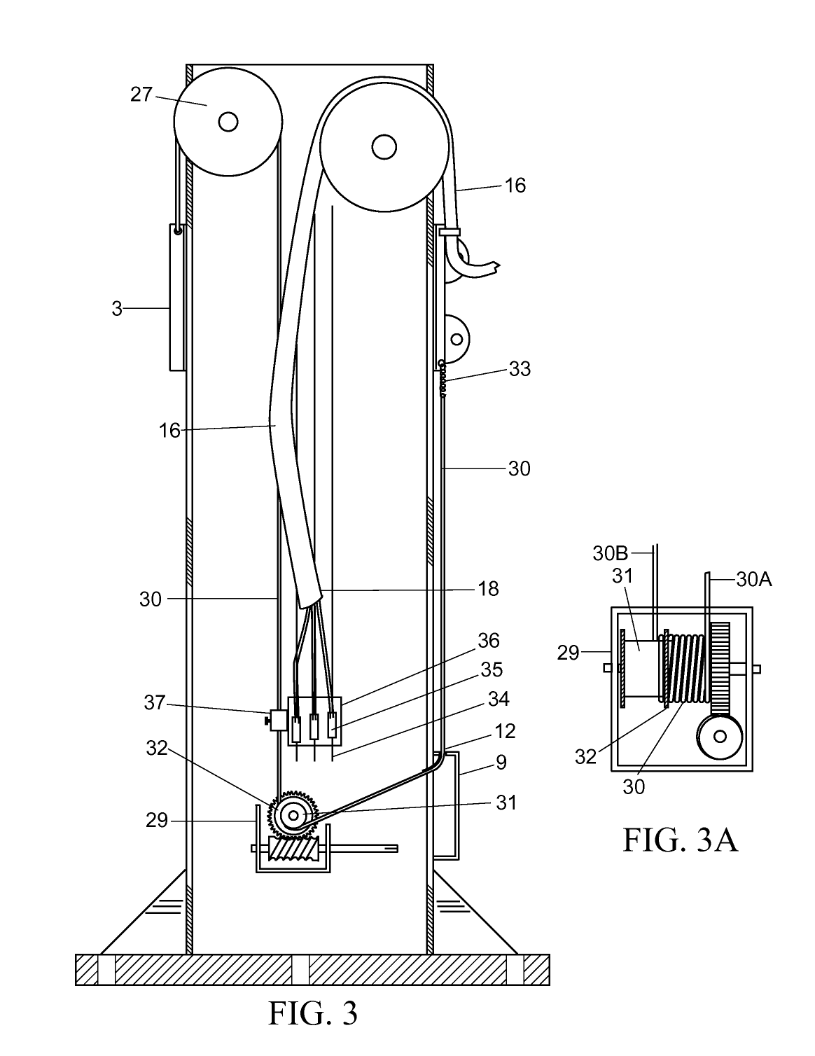

FIG. 3 is a cross section of mast 2 showing winch 29 which has only one cable 30 wound around drum 31. One end of cable 30 is attached to movable device 3 and the other end of cable 30 is attached to accumulator 33 which is attached to movable object 3.

FIG. 3A shows winch 29 with drum 31 segregated into two winding areas by a central separator 32. Cable 30 is pre-wound in such a way that as drum 31 rotates, cable segment 30A plays out as segment 30B is wound in. Since one winding area of drum 31 eventually accumulates a second or third layer of cable while the other winding area contains only one layer, there is a differential winding ratio which is compensated for by accumulator 33 attached to one end of cable 30 and movable device 3

Method

Movable device 3 with attached electrical panel 13 is slidably connected to hollow mast 2. Movable device 3 is raised up to its optimum operating height by an elongated flexible member 4, 23, 30. It may be secured at this height by member 4, 23, 30 or reversibly locked in place. During the raising phase, the excess coiled cable 20 is pulled up and over upper roller 19 and stores itself inside hollow mast 2 by compressing its extended coils. This coiling process is aided by guides 21 attached to alternate coils which travel along vertically stretched guide wires 22. This prevents the coils from overlapping as they naturally want to do. Elongated member 4, 23, 30 is caused to move in one direction or another by winch 6 operated by crank 7.

Alternatively, coiled power conductor 20 is replaced by a system of conducting rails 34 fixed vertically inside mast 2. The electrical cable 16 attached to movable device 3 rides up and over upper roller 19 and now can extend without coils to the base 1 when the movable device 3 is at the top of the mast. The lower end of this cable 16 terminates in slidable contactors 35 that ride on rails 34. A shorter segment of electrical cable 16 is thus required, lowering the electrical resistance and thus improving the system output. This also eliminates the coiling problems encountered with the coiled cable 20.

I claim:

1. A means of moving a device slidably attached to a pole or mast consisting of
(a) a hollow pole or mast
(b) a device that slidably attaches to the pole or mast
(c) two rollers attached near the top of the pole or mast
(d) a motive device, located near the base of the pole or mast, able to move the elongated member in one direction or the other.
(e) an elongated flexible member, one end of which is attached to the movable device, the other end of which travels over one of the upper roller, down the mast, over the motive device, and back up to be attached to the movable device.
(f) a means of applying rotational movement to the motive device.
(g) a coiled electrical cable, composed of several isolated conductors, inside the mast extending from base to top and thence over the second roller, proceeding outside the mast and connecting to the movable device.

2. The means of moving a device slidably attached to a pole or mast set forth in claim 1, wherein the motive device is located inside a hollow pole or mast with the section of elongated member between the motive device and upper roller traveling inside the pole or mast and access to the motive device is through a hole or hatch in the lower area of the pole or mast.

3. The means of moving a device slidably attached to a pole or mast set forth in claim 2, wherein the elongated flexible member is a chain and its respective upper roller is an idler sprocket.

4. The means of moving a device slidably attached to a pole or mast set forth in claim 3, wherein the motive device is a winch driven sprocket.

5. The means of moving a device slidably attached to a pole or mast set forth in claim 4, wherein the coiled conductor is guided as it stretches or collapses by straps, periodically attached to coils, which slide vertically on guide cables stretched vertically inside the mast.

6. The means of moving a device slidably attached to a pole or mast set forth in claim 4, wherein the elongated member is a cable.

7. The means of moving a device slidably attached to a pole or mast set forth in claim 6, wherein the upper roller is a grooved roller or idler pulley and the motive device is a winch with a drum that is segregated into two sections, wound so that one draws in cable, while the other section plays out cable as the drum rotates in one direction.

8. The means of moving a device slidably attached to a pole or mast set forth in claim 7, wherein a tensioner is inserted into one section of the cable.

9. The means of moving a device slidably attached to a pole or mast set forth in claim 7, wherein the motive device is a winch with two simultaneously rotating drums wound such that one drum draws in cable, while the other drum plays out cable as the winch rotates in one direction.

10. The means of moving a device slidably attached to a pole or mast set forth in claim 4, wherein there is
(g) a plurality of electrical conducting rails fastened inside the mast extending from base to nearly the top.
(h) the coiled electrical cable is replaced by a shorter non-coiled electrical cable, one end of which is attached to the movable device and the remainder flexes as it passes over its respective upper roller and extends downward inside the mast to the base when the movable device is at it up-most position, ending in slidable contactors riding on the electrical rails therein.
